(19) United States
(12) Patent Application Publication
(10) Pub. No.: US 2003/0011424 A1
(43) Pub. Date: Jan. 16, 2003

(54) Simultaneous switching noise minimization technique for power lines using dual layer power line mutual inductors

(76) Inventors: Gyu Moon, Kangwon-Do (KR); Hyun Yun, Seoul (KR); Yongha Lee, Kyungki-Do (KR)

Correspondence Address: Thomas V Smurzynski, Lahive & Cockfield, 28 State Street, Boston, MA, 02109, US

(21) Appl. No.: 09/980,136

(22) PCT Filed: Mar. 22, 2001
(86) PCT No.: PCT/KR01/00452

(30) Foreign Application Priority Data
Mar. 29, 2000 (KR) 2000-15997

(51) Int. Cl. G05F 3/02

(52) U.S. Cl. 327/565; 327/545

(57) ABSTRACT

The object of this invention is to minimize a simultaneous switching noise of the mutual inductor on PCB and a noise generated by large buffers' simultaneous switching. An instant large current in the power line is half-divided flowing through two different but closely coupled layers in opposite directions. This configuration is effective to minimize the simultaneous switching noise. This mutual inductance between two power layers enables us to significantly minimize the switching noise.

### TECHNICAL FIELD

The present invention relates in general to a simultaneous switching noise minimization technique for power lines using dual-layer power line mutual inductors, which minimize power line noise generated by a simultaneous switching operation of large buffers (or drivers) connected to input/output(I/O) terminals on a chip of an integrated circuit(IC) or a printed circuit board(PCB), and more particularly to an apparatus for minimizing simultaneous switching noise on power lines using dual-layer power line mutual inductors by designing the mutual inductors using dual-layer power lines on a chip or a PCB, making the electric currents generated from the buffers flow in opposite directions with the same change amount, and generating a magnetic force, thus effectively reducing a noise voltage by the magnetic force.

### BACKGROUND ART

As well known to those skilled in the art, the input/output(I/O) terminals of a circuit integrated with a chip are inevitably connected to large buffers to normally operate for interfacing with a circuit outside the chip. Recently, as integration techniques have been developed, a chip with high-integrity has been proposed and used. Further, the chip includes a plurality of inputs and outputs for performing multiple functions, and operates at high speed. Then, the numbers of the input/output buffers at high speed have been increased and switched simultaneously. However, due to the simultaneous switching operation, a sudden current flows through the power line by a parasitic inductor generated on the power line connected to the buffer, thus resulting in a distortion of the power supply voltage applied to the power line. FIG. 1 is a view showing the simultaneous switching noise generated due to the parasitic inductor on the power line of the PCB.

FIG. 2 is a circuit diagram showing a model of input/output(I/O) buffers and parasitic inductors arranged on their power lines.

Referring to FIG. 2, in the I/O buffers 101 through 10n, a pull-up transistor 10a and a pull-down transistor 10b are connected between a power line V_{DD} and another power line V_{SS}. Drains of both transistors 10a and 10b are commonly connected to an output terminal, and gates thereof are commonly connected to a signal input terminal Vin. Recently, more and more I/O buffers are connected between the power lines V_{DD} and V_{SS} in parallel.

Further, a parasitic inductor L_{VDD} is arranged between the power line V_{DD} and the pull-up transistor 10a, and a parasitic inductor L_{VSS} is arranged between the power line V_{SS} and the pull-down transistor 10b.

Here, simultaneous switching noise(SSN) on a node A is represented by the Equation 1 below,

$$V n = n {L}_{V S S} \frac{ⅆ I}{ⅆ T} \qquad [ 1 ]$$

wherein Vn is simultaneous switching noise, and n is the number of output buffers. It should be noted from Equation 1, that the simultaneous switching noise is increased as the inductance of the inductor L_{VSS} is increased or a current change amount dI is increased.

FIG. 3 is a graph showing noise generated when 25, 50, and 100 I/O buffers, respectively, are switched simultaneously with a power supply voltage of 3.3V as an example. As shown in FIG. 3, the power line distortion due to the noise causes an enormous interference with a stable operation of the chip.

Recently, a plurality of studies for reducing such noise have advanced. However, as a method to effectively reduce the noise shown in FIG. 3 has not yet been disclosed, more complex, and many additional circuits are required to reduce it. Specifically, various methods have been proposed to reduce the noise, and one of them, which optimizes the size of the buffer by the use of a multi-stage buffer, is disadvantageous in that it cannot eliminate much noise. And another method of reducing noise by slowing down the change of current flowing through the parasitic inductor is disadvantageous in that it makes the operation speed of the buffer slow. So, a plurality of pull-down transistors are additionally used to compensate for reduction in the operation speed. However, such method runs counter to the recent trend of compactness and smallness of the circuits as well as being incompatible with the recent increasing numbers of I/O buffers. Still another method of reducing the noise by reducing the parasitic inductance on the power line using multi-layer power lines is problematic in that it cannot remove the inductance perfectly, thus, a quantity of noise remaining.

### DISCLOSURE OF THE INVENTION

Therefore, the present invention has been made in view of the above problems, and it is an object of the present invention to provide an apparatus for minimizing simultaneous switching noise on power lines using dual-layer power line mutual inductors, by arranging two power lines closely to each other based on the fact that when two inductors are close to each other, noise voltage can be offset by magnetic force generated by currents flowing through the two inductors in opposite directions simultaneously, thus naturally removing the noise effectively; the apparatus having a simple design without occupying additional chip area.

In accordance with the present invention, the above and other objects can be accomplished by the provision of an apparatus for minimizing simultaneous switching noise on power lines using dual-layer power line mutual inductors, comprising an input/output(I/O) buffer having a pull-up transistor(M1) and a pull-down transistor(M2) and connected between power lines(V_{DD}) and (V_{SS}), of which an output terminal is commonly connected to both drains of the transistors(M1, M2), and a signal input terminal is commonly connected to both gates thereof, wherein the I/O buffer is divided into two small buffers each half the size of the I/O buffer, one of which includes a pull-up transistor(M11) and a pull-down transistor(M21), and the other includes a pull-up transistor(M12) and a pull-down transistor(M22), and the pull-up transistor(M11) and the pull-down transistor(M21) are connected between first power lines (V_{DD1}) and (V_{SS1}), while the pull-up transistor(M12) and the pull-down transistor(M22) are connected between second power lines(V_{DD2}) and (V_{SS2}), wherein the first power lines(V_{DD1}) and (V_{SS1}) are closely horizontally arranged in parallel with the second power lines (V_{DD2}) and (V_{SS2}), respectively, with an insulation layer interposed between the first and second power lines having the same width, and currents flowing in the power lines in opposite directions.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing simultaneous switching noise by a parasitic inductor on power lines on the PCB;

FIG. 2 is a circuit diagram showing a parasitic inductor of a conventional output buffer;

FIG. 3 is a graph showing noise generated on a node A by simultaneous switching of the output buffers shown in FIG. 2;

FIG. 4 is a schematic circuit diagram showing a reduction in simultaneous switching noise by the use of two-layer power lines according to the present invention;

FIG. 5 is a view showing an equivalent model of primary and secondary inductors L_{VSS} and L′_{VSS} shown in FIG. 4;

FIG. 6 is a graphic diagram showing a reduction in simultaneous switching noise according to a coupling coefficient k of the power line of this invention;

FIG. 7a is a view showing a dual-layer power line mutual inductor for V_{SS}, and V_{DD} on the PCB and IC of this invention;

FIG. 7b is a perspective view showing the structure of the dual-layer power line on the PCB and IC of this invention;

FIG. 8 is a circuit diagram showing an output buffer of the IC using the dual-layer power line mutual inductor of this invention;

FIG. 9 is a view showing a layout example of an input/output buffer having the dual-layer power line mutual inductor on the IC of this invention; and

FIG. 10 is a view showing a layout example of the dual-layer power line for 2-metal process on the IC of this invention.

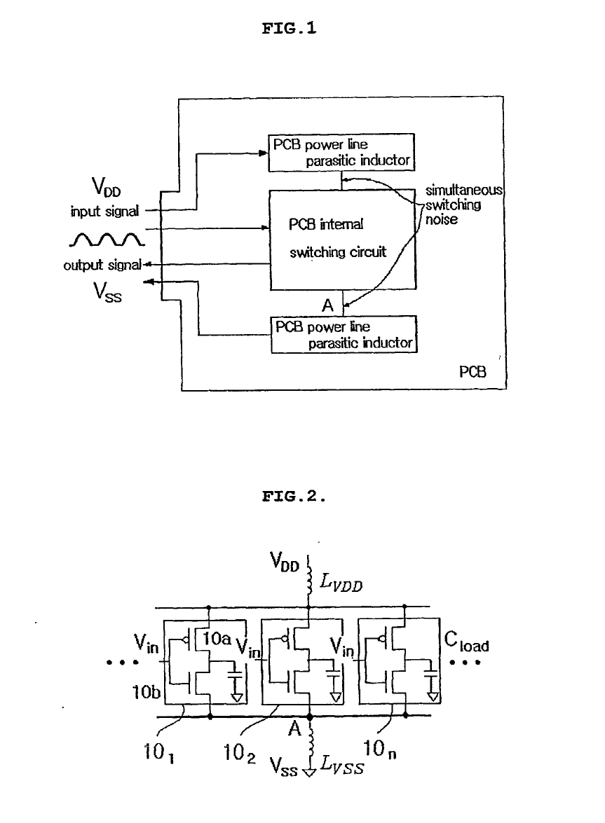

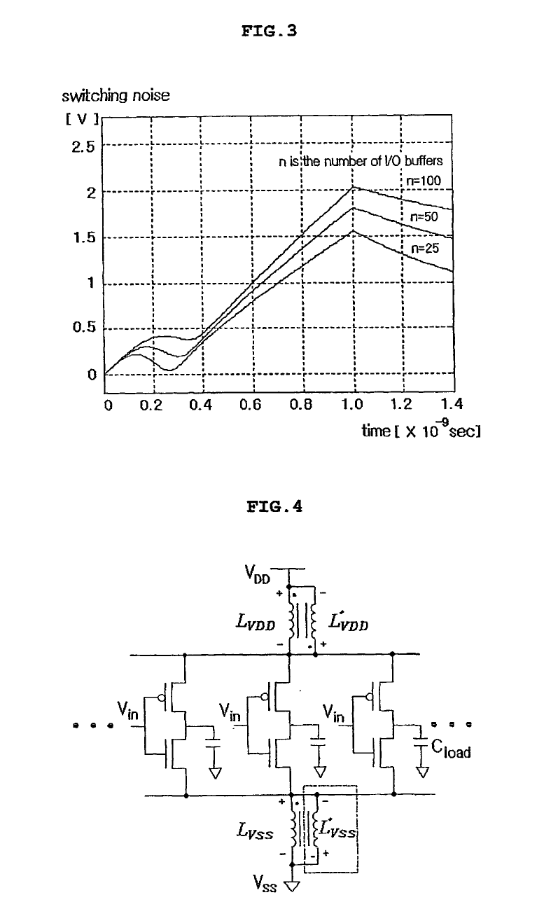

### BEST MODE FOR CARRYING OUT THE INVENTION

FIG. 4 is a circuit diagram having currents flowing in opposite directions through two inductors on two adjacent power lines, and the two inductors are shown as a transformer in FIG. 4.

The operations of removing the simultaneous switching noise on the power lines V_{DD} and V_{SS}, respectively, are the same, and for avoiding a repetitive description, only the operation with respect to the power line V_{SS} will be described. Further, a parasitic inherent inductor on the power line V_{SS} is defined as a primary inductor L_{VSS}, and an additive inductor shown with a dotted line in FIG. 4 is defined as a secondary inductor L′_{VSS}. The inductors L_{VSS} and L′_{VSS} are not real inductors formed by winding a coil, but parasitic inductors contained in the power line itself.

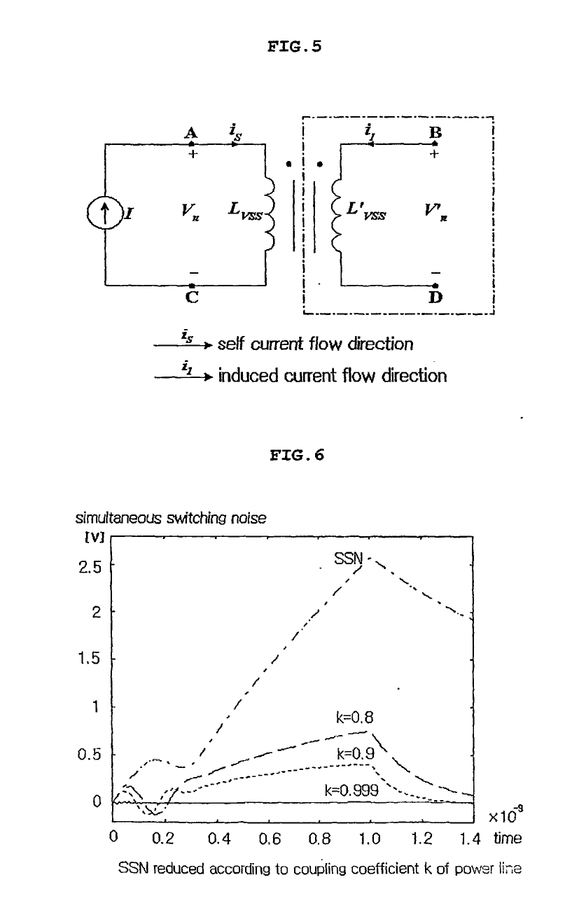

FIG. 5 is a view showing an equivalent model of the primary and secondary inductors L_{VSS} and L′_{VSS} shown in FIG. 4 for description of the reducing operation of the simultaneous switching noise generated by the primary inductor L_{VSS} on the power line V_{SS}. Referring to FIG. 5, if a first node A is connected to a fourth node D, and a second node B is connected to a third node C, the equivalent model of FIG. 5 is identical with the circuit of FIG. 4.

First, Vn and V′n are represented by the Equations 2 and 3, respectively,

$$\begin{matrix}V n = {L}_{V S S} \frac{ⅆ {i}_{S}}{ⅆ t} + M \frac{ⅆ {i}_{I}}{ⅆ t} & [ 2 ] \\ {V}^{′} n = {L}_{V S S}^{′} \frac{ⅆ {i}_{I}}{ⅆ t} + M \frac{ⅆ {i}_{S}}{ⅆ t} & [ 3 ]\end{matrix}$$

wherein M is a mutual inductance generated by magnetic force. When the primary and secondary inductances L_{VSS}, L′_{VSS} are the same in their values and insulated from each other by a very thin insulator, the inductances L_{VSS}, L′_{VSS} and the mutual inductance M are almost the same. In this case, it can be represented that the inductors L_{VSS} and L′_{VSS} are preferably coupled together, and a coupling coefficient k indicates the degree of coupling. The coupling coefficient k can be obtained by the Equation 4 below.

$$k = \frac{M}{\sqrt{{L}_{V S S} {L}_{V S S}^{′}}} \qquad [ 4 ]$$

Then, if the two inductances L_{VSS} and L′_{VSS} and the mutual inductance M are the same, it is confirmed that k is close to ‘1’.

Referring to FIG. 5, when the nodes A through D are connected to each other as described above, Vn equals to −Vn, and then, the following Equation 5 is obtained from the Equations 2 and 3.

$${V}_{n} + {V}_{n}^{′} = ( {L}_{V S S} \frac{ⅆ {i}_{S}}{ⅆ t} + M \frac{ⅆ {i}_{I}}{ⅆ t} ) + ( {L}_{V S S}^{′} \frac{ⅆ {i}_{I}}{ⅆ t} + M \frac{ⅆ {i}_{S}}{ⅆ t} ) = 0 \qquad [ 5 ]$$

If the coupling coefficient k is close to ‘1’, M≅L_{VSS}=L′_{VSS}, and then, the Equation 5 can be represented again as the following Equation 6.

$$\begin{matrix}{V}_{n} + {V}_{n}^{′} = ( {L}_{V S S} \frac{ⅆ {i}_{S}}{ⅆ t} + {L}_{V S S} \frac{ⅆ {i}_{I}}{ⅆ t} ) + ( {L}_{V S S} \frac{ⅆ {i}_{I}}{ⅆ t} + {L}_{V S S} \frac{ⅆ {i}_{S}}{ⅆ t} ) \\ = ( {L}_{V S S} \frac{ⅆ {i}_{S}}{ⅆ t} + {L}_{V S S} \frac{ⅆ {i}_{I}}{ⅆ t} ) \\ = 0\end{matrix} \qquad [ 6 ]$$

So, the Equation 7 below is obtained from the Equation 6.

$$\frac{ⅆ {i}_{S}}{ⅆ t} + \frac{ⅆ {i}_{I}}{ⅆ t} = 0 \qquad [ 7 ]$$

If the Equation 7 is inserted into the Equations 2 and 3, the following Equation 8 can be obtained as below.

$$\begin{matrix}{V}_{n} = {V}_{n}^{′} = {L}_{V S S} \frac{ⅆ {i}_{S}}{ⅆ t} + M \frac{ⅆ {i}_{I}}{ⅆ t} \\ = {L}_{V S S} \frac{ⅆ {i}_{S}}{ⅆ t} + {L}_{V S S} \frac{ⅆ {i}_{I}}{ⅆ t} \\ = {L}_{V S S} \cdot ( \frac{ⅆ {i}_{S}}{ⅆ t} + \frac{ⅆ {i}_{I}}{ⅆ t} ) \\ = {L}_{V S S} \cdot 0 = 0\end{matrix} \qquad [ 8 ]$$

In other words, in case that the two power lines are arranged closely using an insulator as an intermediary, if the power lines are perfectly coupled, the simultaneous switching noise can be reduced to “0”. For perfect coupling, the primary and secondary inductors L_{VSS} and L′_{VSS} must be the same and arranged very closely. Additionally, the currents in the inductors must flow in opposite directions and in the same amounts.

FIG. 6 is a graphic diagram showing the noise reduced by the circuit shown in FIG. 4, comparing with the noise before the reduction. As described above, k is a coupling coefficient by magnetic force between two power lines. So it should be noticed that as k is designed to more and more closely approximate ‘1’, the noise gradually approaches to ‘0’.

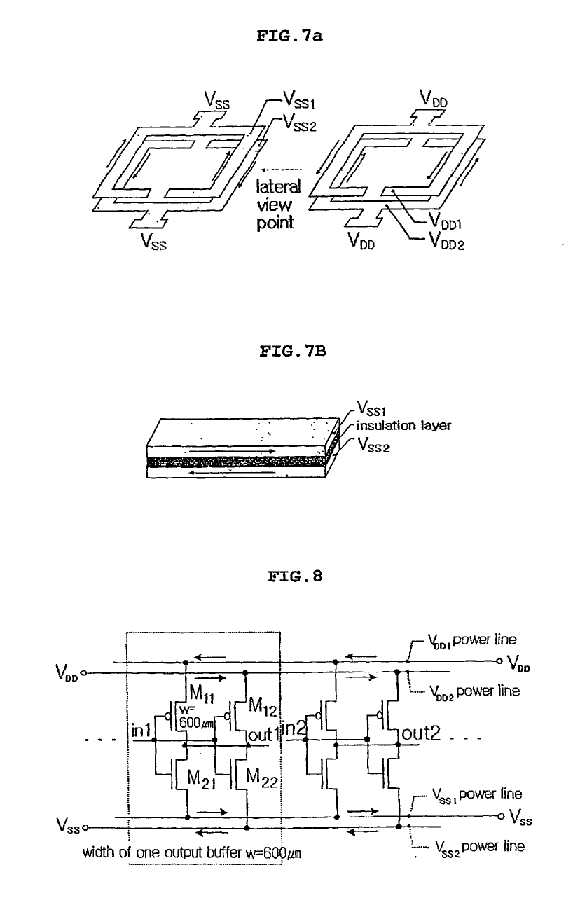

Thus, as shown in FIG. 6, the coupling coefficient k is a very significant factor in the present invention. Because of this importance of k, a power line V_{DD} and another power line V_{SS} consist of two stacked power lines with the same width, respectively, as shown in FIG. 7a and FIG. 7b, thus, forming a mutual inductance. The two stacked power lines are defined as a ‘dual-layer power line’.

FIG. 7a is a view showing a dual-layer power line mutual inductor for V_{SS}, and V_{DD}, and FIG. 7b is a perspective view showing the structure of the dual-layer power line. Referring to FIGS. 7a and 7b, the power lines V_{DD1}(or V_{SS1}) and V_{DD2}(or V_{SS2}) are horizontally parallely arranged with an insulation layer interposed between the two power lines. The first power lines V_{DD1} and V_{SS1} are formed symmetrical with the second power lines V_{DD2}, and V_{SS2}, respectively, such that the parasitic inherent inductances of the two symmetrical power lines are the same.

Here, it is further observed that when the I/O buffers are separately connected to the first power lines V_{DD1}, V_{SS1}, and the second power lines V_{DD2}, V_{SS2}, respectively, the same numbers of buffers operate simultaneously, and it is difficult to obtain the current with the same change amounts. To solve the problem, a circuit of FIG. 8 is designed.

FIG. 8 is a circuit diagram showing an output buffer using the dual-layer power line mutual inductor. Referring to FIG. 8, the output buffer with a large size is divided into two buffers each half the size of the output buffer. One of the two buffers, including a pull-up transistor M11 and a pull-down transistor M21 is connected between the first power lines V_{SS1}, and V_{DD1}, and the other including a pull-up transistor M12 and pull-down transistor M22 is connected between the second power lines V_{SS2} and V_{DD2}. The input/output terminals of the one buffer are connected to those of the other, thus forming a single buffer. For example, in order to compose a large output buffer with a channel width of 600 μm, two half-sized buffers with a channel width of 300 μm, respectively, are required. In this case, the first power lines V_{SS1}, V_{DD1} and the second power lines V_{SS2}, V_{DD2} are connected to the two half-sized output buffers, respectively, which enables the currents with the same change amounts to flow simultaneously through the two power lines V_{DD1}, V_{SS1}, and V_{DD2}, V_{SS2}. Therefore, the dual-layer power lines do not require a large area to be arranged in the layout of the IC.

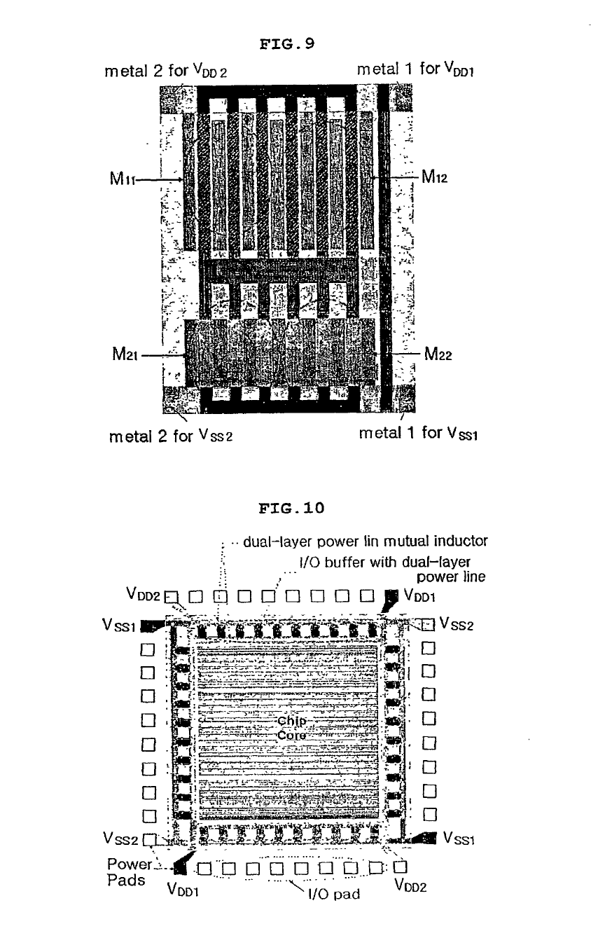

FIG. 9 is a view showing a layout of input/output buffer(or driver) having the dual-layer power line mutual inductor as shown in FIG. 8. Referring to FIG. 9, the transistor M11 and the transistor M21 with half the size of the transistor M11 are connected between the first power lines V_{DD1} and V_{SS1}, and the transistor M12 and the transistor M22 half the size of the transistor M12 are connected between the second power lines V_{DD2} and V_{SS2}. Both the first power lines VDD1 and V_{SS1} use a metal 1, and the second power lines V_{DD2} and V_{SS2} use a metal 2. The structure of the output buffer using a dual-layer power line mutual inductor shown in FIG. 9 is different from the conventional output buffer in that it has additionally the second power lines such as V_{DD2} and V_{SS2}. The second power lines V_{DD2} and V_{SS2} are not shown in FIG. 9, because of its horizontal arrangement in parallel with the first power lines V_{DD1} and V_{SS1}.

Preferably, the layout shown in FIG. 9.is changed as a layout shown in FIG. 10 when it is desired to integrate the layout of FIG. 9 with the structure of FIG. 7a in a 2-metal process. FIG. 10 is a view showing a sample layout of the dual-layer power line for 2-metal process. In the dual-layer power lines, the power lines V_{DD} and V_{SS} use both metals 1 and 2, and then, when connecting the power lines V_{DD} and V_{SS} to a power pad, there may be some problem that one power line such as V_{DD} cannot cross over another power line such as V_{SS}. Thus, in order to solve the problem, the layout of the dual-layer power lines in 2-metal process is proposed as shown in FIG. 10. The layout as shown in FIG. 10 is effective in that typically power pad frames generally provided by a supplier are located at a corner of a chip package. However, it should be noted that more power line layers could be provided in the package with a variable structure as another example.

As stated above, the layout structure of dual-layer power line is mainly described with respect to the IC, however, the structure can be applied to a PCB. In this case, the power line on the PCB is divided into two layers such that currents flow through the two layers in opposite directions. Thus, based on the above operation, the simultaneous switching noise generated by the parasitic inductor on the PCB can be minimized.

Industrial Applicability

As apparent from the above description, the present invention provides an apparatus for minimizing simultaneous switching noise on power lines using dual-layer power line mutual inductors, which forms a mutual inductor using a dual-layer power line, and makes currents generated by the buffer flow through the dual-layer power lines in opposite directions with the same change amounts, thus effectively minimizing power line noise generated by a simultaneous switching operation of large buffers connected to the input/output terminals on an IC or a PCB; the apparatus having a simple structure without occupying any additional area.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An apparatus for minimizing simultaneous switching noise on power lines using dual-layer power line mutual inductors, comprising an input/output(I/O) buffer having a pull-up transistor(M1) and a pull-down transistor(M2) and connected between power lines(V_{DD}) and (V_{SS}), of which an output terminal is commonly connected to both drains of the transistors(M1, M2), and a signal input terminal is commonly connected to both gates thereof, wherein:
the I/O buffer is divided into two small buffers each half the size of the I/0 buffer, one of which includes a pull-up transistor(M11) and a pull-down transistor(M21), and the other includes a pull-up transistor(M12) and a pull-down transistor(M22), and
the pull-up transistor(M11) and the pull-down transistor(M21) are connected between first power lines (V_{DD1}) and (V_{SS1}), while the pull-up transistor(M12) and the pull-down transistor(M22) are connected between second power lines(V_{DD2}) and (V_{SS2}),
wherein the first power lines(V_{DD1}) and (V_{SS1}) are closely horizontally arranged in parallel with the second power lines (V_{DD2}) and (V_{SS2}), respectively, with an insulation layer interposed between the first and second power lines having the same width and currents flowing in the power lines in opposite directions.

2. The apparatus as set forth in claim 1, wherein currents with the same change amounts flow in opposite directions through the first power lines (V_{DD1}, V_{SS1}) and the second power lines(V_{DD2}, V_{SS2}), respectively.

3. The apparatus as set forth in claim 1, wherein the first power lines(V_{DD1}, V_{SS1}) and the second power lines(V_{DD2}, V_{SS2}) are power lines formed on a PCB having a dual-layer structure.

4. The apparatus as set forth in any one of claims 1 to 3, wherein the first power lines(V_{DD1}, V_{SS1}) and the second power lines(V_{DD2}, V_{SS2}) are power lines formed on an integrated circuit(IC) having a multi-layer structure.
